(19) United States
(12) Patent Application Publication
(10) Pub. No.: US 2009/0267325 A1
(43) Pub. Date: Oct. 29, 2009

(54) Collapsible stroller

(76) Inventors: Michael Cavins, Marysville, OH (US); Sarah Kay Stout, Clayton, OH (US); Daniel R. Fox, Greenville, OH (US); Stephen T. English, Englewood, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/150,178

(22) Filed: Apr. 25, 2008

(51) Int. Cl. B62B 7/06

(52) U.S. Cl. 280/642

(57) ABSTRACT

A collapsible stroller having a frame including a pair of S-shaped members pivotably joined together at their inflection points, a lower frame assembly suspended by L-shaped brackets, a handle extension mechanism, and a soft goods storage console. The S-shaped frame members and L-shaped bracket mounting of the lower frame assembly provide improved access to a storage volume located beneath the seat.

### BACKGROUND OF THE INVENTION

This invention relates to collapsible strollers. Specifically, the present invention relates to an improved collapsible stroller having a frame including a pair of S-shaped members pivotably joined together at their inflection points, a lower frame assembly suspended by L-shaped brackets, a handle extension mechanism, and a soft goods storage console.

Strollers, and collapsible strollers in particular, are generally known. Such strollers typically include a frame constructed of a plurality of tubular members. The tubular members often include a pair of forward legs, a pair of rearward legs, and a pair of handles. The tubular members are often connected by joints that allow the stroller to be pivoted between a collapsed configuration and an operative configuration.

### BRIEF SUMMARY OF THE INVENTION

In a first aspect, a stroller according to the present invention may include a first frame member having generally an S-shape with a first inflection point; a second frame member having generally an S-shape that is approximately a mirror image of the first frame member and the second frame member having a second inflection point; wherein the first frame member and the second frame member are pivotably coupled together proximate the first inflection point and the second inflection point such that the first frame member and second frame member form a substantially coplanar X-shape.

In a detailed embodiment of the first aspect, the first frame member and the second frame member may each have a first end and a second end and wherein a length from the first end of the first frame member to the first inflection point may be greater than a length from the second end of the first frame member to the first inflection point. The first frame member and the second frame member may comprise a generally vertical support frame pivotably connected to lower frame members and upper frame members.

In a second aspect, a stroller according to the present invention may include a frame having a vertical supporting member and a lower separator assembly; wherein the lower separator assembly is suspended from the vertical supporting member by a bracket such that the lower separator assembly is oriented substantially horizontally and such that substantially all of the lower separator assembly is located beneath the vertical height at which the bracket is attached to the vertical supporting member.

In a detailed embodiment of the second aspect, the bracket may be an L-shaped bracket. The bracket may be pivotably coupled to the vertical supporting member using at least one axial coupling member. The bracket may be pivotably coupled to the lower separator assembly using at least one axial coupling member.

In a third aspect, a stroller according to the present invention may include a frame having a first upper frame member, and a second upper frame member; a first handle; and a second handle; wherein the first handle is slidably coupled with the first upper frame member and the second handle is slidably coupled with the second upper frame member such that each of the first handle and the second handle is independently movable.

In a detailed embodiment of the third aspect, the stroller may further include a first pin extending perpendicularly through the first frame member; a second pin extending perpendicularly though the second frame member; a first spring retainer mounted within the first frame member and including a first button extending through a first hole in the first frame member, the button being spring-biased radially outward from a center of the first frame member; a second spring retainer mounted within the second frame member and including a second button extending through a second hole in the second frame member, the second button being spring-biased radially outward from a center of the second frame member; a first collar rigidly attached to the first handle and slidably attached to the first upper frame member and having a longitudinal trough adapted to slidably receive the first pin and a plurality of holes adapted to engage the first button; and a second collar rigidly attached to the second handle and slidably attached to the second upper frame member and having a longitudinal trough adapted to slidably receive the first pin and a plurality of holes adapted to engage the second button. The first handle and the second handle may have larger diameters than the first upper frame member and the second upper frame member. The first handle and the second handle may be at least partially covered with foam.

In a fourth aspect, a stroller according to the present invention may include a frame, the frame including handles; a storage console mounted to the frame proximate the handles, the storage console comprising a pliant material; wherein the storage console includes a plurality of pockets.

In a detailed embodiment of the fourth aspect, the plurality of pockets includes at least one pocket adapted to hold a beverage container. The plurality of compartments may include at least two beverage pockets, each beverage pocket adapted to hold a beverage container, and at least one center pocket located between the beverage pockets. The stroller may further include a pocket located generally beneath the beverage pockets and the center pocket. At least one of the pockets may include a zipper. The pliant material may comprise a woven fabric, a non-woven fabric, and/or a mesh material. At least a portion of the storage console may be releaseably attached to the frame.

### BRIEF DESCRIPTION OF THE SEVERAL VIEWS OF THE DRAWINGS

The detailed description particularly refers to the accompanying figures in which:

FIG. 1 is an isometric view of an exemplary embodiment of a collapsible stroller according to the present invention;

FIG. 2 is an isometric view of an exemplary embodiment of a collapsible stroller frame according to the present invention;

FIG. 3 is a plan view of an exemplary embodiment of a collapsible stroller frame according to the present invention;

FIG. 4 is a rear elevation view of an exemplary embodiment of a collapsible stroller frame according to the present invention;

FIG. 5 is a side elevation view of an exemplary embodiment of a collapsible stroller frame according to the present invention;

FIG. 6 is an isometric view of an exemplary embodiment of a collapsible stroller frame according to the present invention in a collapsed configuration;

FIG. 7 is an elevation view of an exemplary embodiment of a soft goods storage console according to the present invention;

FIG. 8 is an elevation view of an alternative exemplary embodiment of a soft goods storage console according to the present invention;

FIG. 9 is a detailed isometric view of an exemplary embodiment of a handle extension mechanism according to the present invention;

FIG. 10 is an exploded isometric view of an exemplary embodiment of a handle extension mechanism according to the present invention;

FIG. 11 is an exploded isometric view of a partially assembled exemplary embodiment of a handle extension mechanism according to the present invention;

FIG. 12 is a detailed section view of an exemplary embodiment of a handle extension mechanism of according to the present invention;

### DETAILED DESCRIPTION OF THE INVENTION

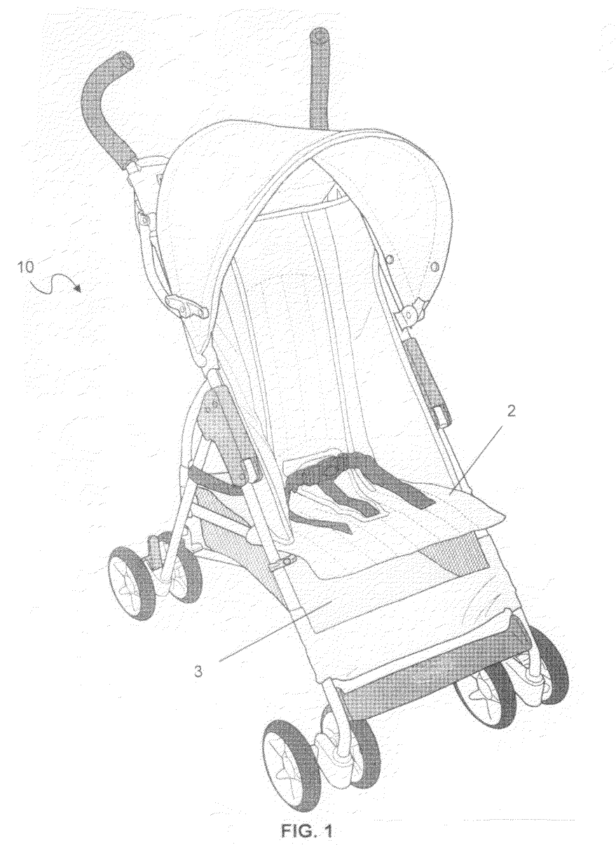

As shown in FIG. 1, an exemplary embodiment of the present invention comprises stroller 10. Stroller 10 is adapted to transport a child in seat 2. The exemplary embodiment depicted in FIG. 1 includes a storage are 3 located beneath the seat 2. The seat 2 and other portions of stroller 10 may be constructed from nylon and/or other fabric and/or mesh in exemplary embodiments. These portions of the stroller 10 are not shown in the remaining Figures.

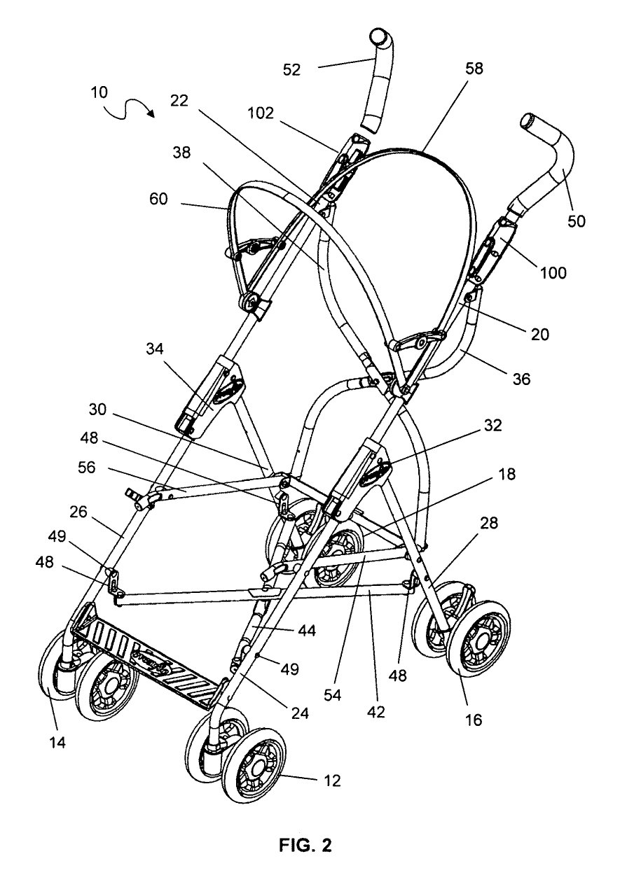

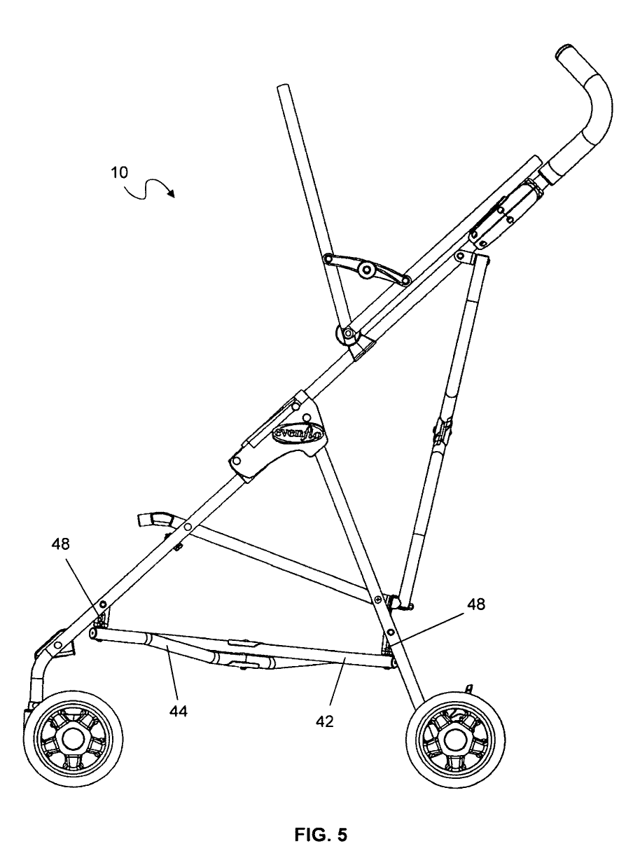

As shown in FIGS. 2-5, an exemplary embodiment of stroller 10 is supported by wheel assemblies 12, 14, 16, 18, each of which includes two wheels. It is within the scope of the invention to utilize wheel assemblies having more or fewer wheels. Front wheel assemblies 12, 14 are mounted to main side tubes 24, 26 such that the wheel assemblies 12, 14 are rotatable in a horizontal plane to permit a user to steer stroller 10. Rear wheel assemblies 16, 18 are rigidly mounted to rear side tubes 28, 30. The rear wheel assemblies 16, 18 may optionally include braking mechanisms adapted to prevent the wheels from rolling when the mechanisms are engaged. Rear side tubes 28, 30 are pivotably attached to couplings 32, 34, respectively. Main sides tubes 24, 26 are pivotally attached to couplings 32, 34, respectively. Upper side tubes 20, 22 are also rigidly attached to couplings 32, 34, respectively.

Handles 50, 52 are coupled to upper side tubes 20, 22 by handle extension mechanisms 100, 102 described in detail below. In an exemplary embodiment, handles 50, 52 may be composed of tubular metal sections covered with foam. The exposed ends of handles 50, 52 may be covered with plastic plugs.

Canopy support hoops 58, 60 are also coupled to upper side tubes 20, 22. In the exemplary embodiment, hoop 60 is pivotable relative to upper side tubes 20, 22 to allow a user to deploy and collapse the canopy.

Seat supports 54, 56 are pivotably coupled to front side tubes 24, 26 and rear side tubes 28, 30, respectively. Seat supports 54, 56 are used for mounting the horizontal portion of the seat.

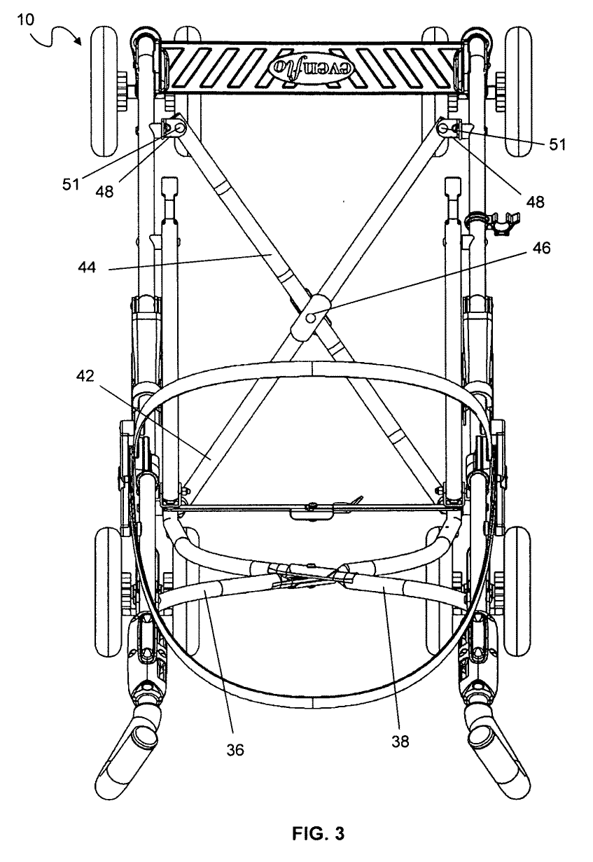

Front side tubes 24, 26 and rear side tubes 28, 30 are held in position by lower cross tubes 42, 44. Lower cross tube 42 is pivotably attached to front side tube 26 and rear side tube 28. Lower cross tube 44 is pivotably attached to front side tube 24 and rear side tube 30. Lower cross tubes 42, 44 are pivotably connected together at pivot 46. As shown in FIG. 3, lower cross tube 44 is bent such that it lies beneath lower cross tube 42 at pivot 46.

Lower cross tubes 42, 44 are pivotably attached to front side tubes 24, 26 and rear side tubes 28, 30 using “L” brackets 48. The vertical portion of each L bracket 48 is pivotably attached to its respective front side tube 24, 26 or rear side tube 28, 30. The horizontal portion of each L bracket 48 is pivotably attached to its respective lower cross tube 42, 44. In exemplary embodiments, these pivotable attachments utilize axial coupling member 49, 51. The axial coupling members 49, 51 may include rivets, through-bolts, and/or similar fasteners known in the art.

In addition to permitting relative rotation in 2 planes, L brackets 48 serve to lower the plane formed by the lower cross tubes 42, 44. By mounting the lower cross tubes 42, 44 lower relative to the seat, additional volume is available for storage beneath the seat.

Upper side tubes 20, 22 and rear side tubes 28, 30 are held in position by rear cross tubes 36, 38. Rear cross tube 36 is pivotably attached to upper side tube 20 and rear side tube 30. Rear cross tube 38 is pivotably attached to upper side tube 22 and rear side tube 28. Rear cross tubes 36, 38 are pivotably joined together at pivot 40.

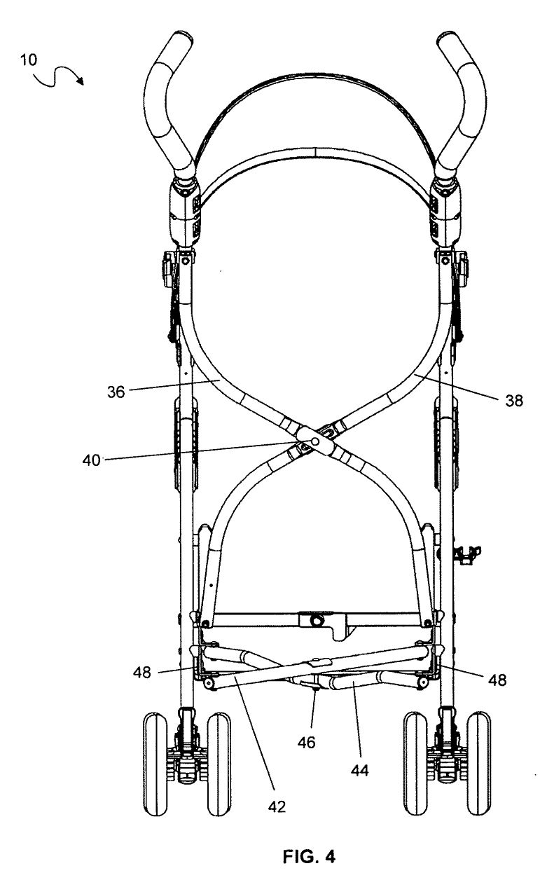

As shown in FIG. 4, rear cross tubes 36, 38 may be curved. The curvature of the rear cross tubes 36, 38 in an exemplary embodiment allows easier access to the storage volume beneath the seat than alternative embodiments that utilize straight rear cross tubes. In the exemplary embodiment, the shape of each rear cross tube 36, 38 is generally a mirror image of the other.

In the exemplary embodiment shown in FIGS. 1-6, the shape of each rear cross tube 36, 38 generally approximates an S-curve, more specifically a sigmoid curve, with the pivot 40 located at the inflection point. Each rear cross tube 36, 38 begins at its bottom end with a nearly straight section that is at a shallow angle relative to its respective rear side tube 28, 30. The curvature of the rear cross tube 36, 38 becomes significant at approximately half way between the bottom end and the pivot 40. The direction of the curvature is towards the pivot 40. The portion of the rear cross tube 36, 38 adjacent to the pivot 40 is approximately straight. The rear cross tube 36, 38 then begins to curve towards a vertical direction, with the final nearly straight section being at a shallow angle relative to upper side tubes 20, 22. In the exemplary embodiment, the upper portion of rear cross tubes 36, 38 (the portion between the pivot 40 and the upper side tubes 20, 22) is longer than the lower portion of the rear cross tubes 36, 38 (the portion between the pivot 40 and the rear side tubes 28, 30). It is within the scope of the invention for the lower portion of the rear cross tubes 36, 38 to be longer than the upper portion or for the lengths of the upper and lower portions to be equal.

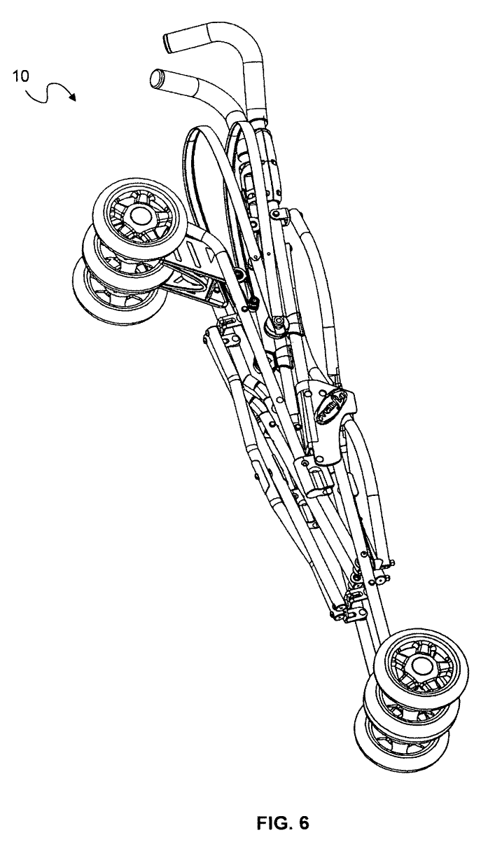

FIG. 6 depicts an exemplary embodiment of the stroller 10 in a collapsed configuration.

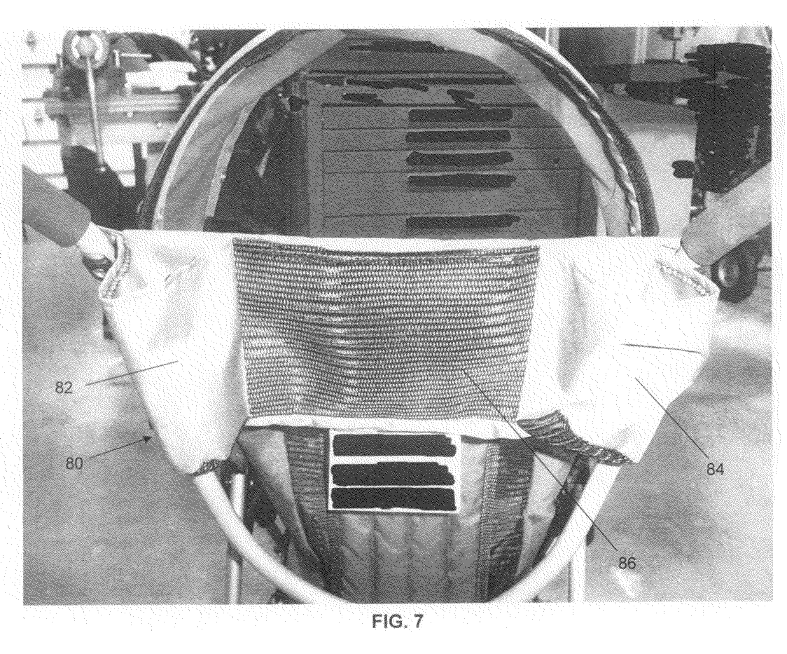

FIG. 7 depicts an exemplary embodiment soft goods storage console 80 according to the present invention. Soft goods storage console 80 may have a plurality of pockets and/or compartments, including drink holders 82, 84 and center pocket 86. Soft goods storage console 80 may be permanently or releaseably attached to the stroller 10 and may be constructed from a fabric. In the exemplary embodiment shown in FIG. 7, the soft goods storage console 80 is attached to the upper side tubes 20, 22. In exemplary embodiments, center pocket 86 and/or the bottoms of drink holders 82, 84 may be constructed of a fabric mesh. Generally, the soft goods storage console may be constructed from any suitable pliant material.

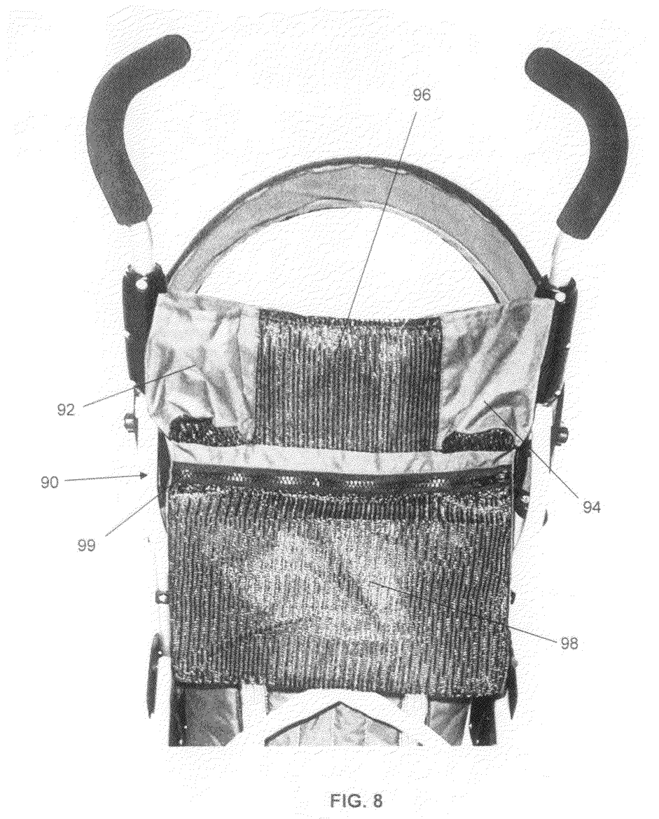

FIG. 8 depicts an alternative exemplary embodiment of a soft goods storage console 90. Similar to soft goods storage console 80, soft goods storage console 90 may be permanently or releaseably attached to stroller 10 and may include a plurality of pockets and/or compartments. The pockets may include drink holders 92, 94, center pocket 96, and lower pocket 98. One or more of the pockets may include a zipper, such as zipper 99 on lower pocket 98. Alternative arrangements of the various pockets and/or compartments is within the scope of the invention.

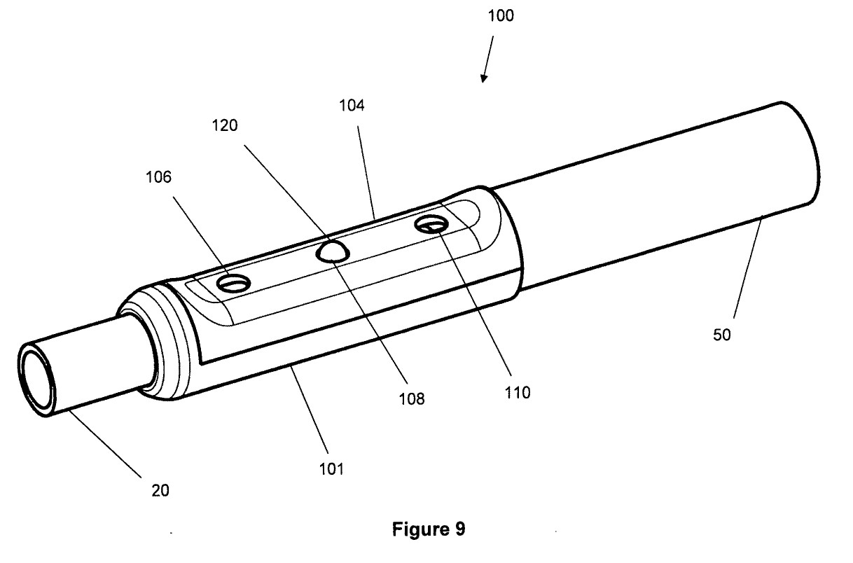

FIG. 9 depicts an exemplary embodiment of the present invention handle extension mechanism 100. In the exemplary embodiment, handle extension mechanisms 100, 102 are mirror images of each other. Thus, the following description of handle extension mechanism 100 also describes corresponding features of handle extension mechanism 102.

Handle extension mechanism 100 slidably couples handle 50 to upper side tube 20. Handle extension mechanism 100 includes a lower portion 101 and an upper portion 104. Handle extension mechanism 100 is rigidly attached to handle 50 and upper side tube 20 is adapted to slide within lower portion 101 and upper portion 104. In an exemplary embodiment, lower portion 101 and upper portion 104 are composed of plastic; however, the use of other materials (such as, but not limited to, metal) is within the scope of the invention.

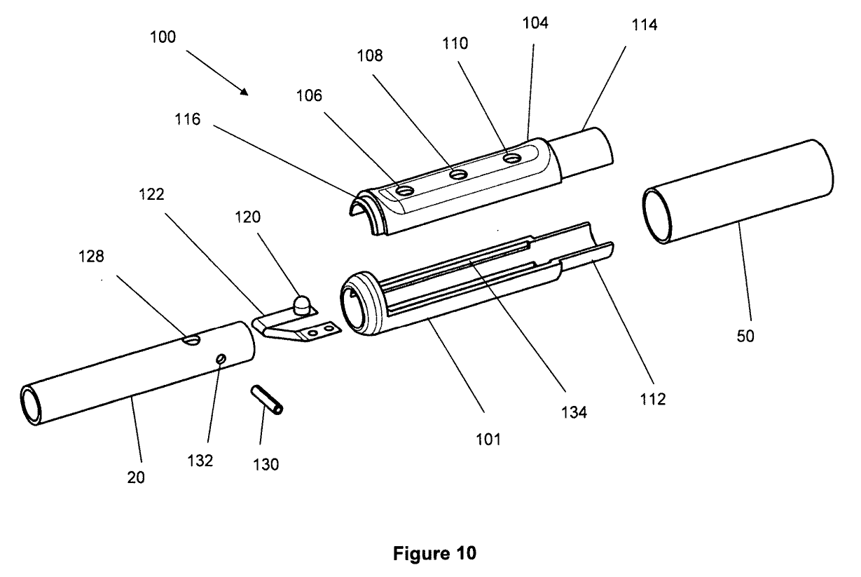

Turning to FIG. 10, it is apparent that the lower portion 101 and upper portion 104 each may have an engagement portion 112, 114 inside which handle 50 is mounted. In an exemplary embodiment, handle 50 may be riveted to either or both of engagement portions 112, 114. Upper portion 104 may include an engagement shoulder 116 adapted to couple with lower portion 101. In an exemplary embodiment, engagement shoulder 116 couples with lower portion 101 using a tongue-in-groove method of engagement. When assembled, spring 122 is located inside of upper side tube 20 such that button 120 extends through hole 128. Button 120 is also mounted to spring 122. Together button 120 and spring 122 comprise a snap button device as is known in the art.

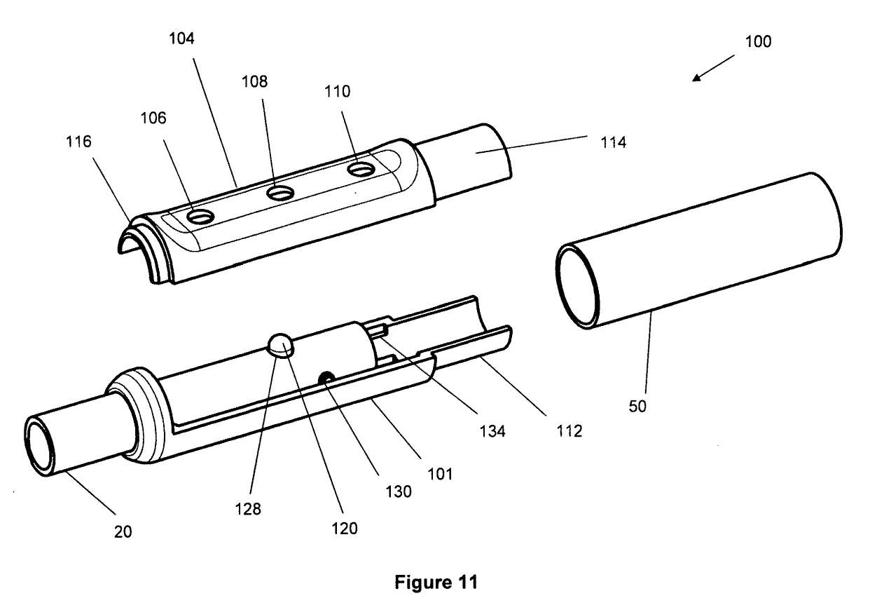

As shown in FIG. 11, spring 122 biases button 120 such that a substantial portion of button 120 extends through hole 128 in upper side tube 20 unless a user depresses button 120 by overcoming the force of spring 122. When assembled, button 120 extends through one of holes 106, 108, 110 in upper portion 104 to lock handle 50 relative to upper side tube 20. In the exemplary embodiment, spring 122 is composed of an elastic metal. It is within the scope of the invention to utilize other materials (such as, but not limited to, plastics) and/or other types of springs (such as, but not limited to, a helical compression spring). In addition, it is within the scope of the invention to include more or fewer holes similar to the holes 106, 108, 110 of the exemplary embodiment.

Returning to FIG. 10, pin 130 is adapted to engage hole 132 such that the ends of pin 130 extend radially beyond the circumference of upper side tube 20. The exposed ends of pin 130 slidably engage troughs 134 which are formed where lower portion 101 and upper portion 104 engage each other. The slidable engagement between pins 130 and troughs 134 allows upper side tube 20 to slide axially within lower portion 101 and upper portion 104. The extent of the axial motion is limited by the length of the troughs 134 such that upper side tube 20 cannot be fully withdrawn from lower portion 101 and upper portion 104. Additionally, the engagement between pins 130 and troughs 134 prevents upper side tube 20 from rotating relative to handle 50. This is advantageous not only because handle 50 remains in the proper angular orientation, but also because it ensures that button 120 is properly aligned to engage holes 106, 108, 110.

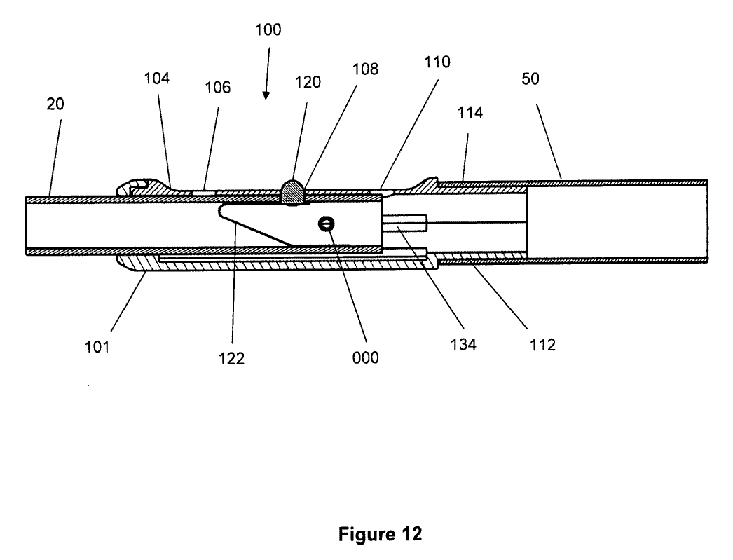

The handle extension mechanism 100 is operated as follows. Beginning, for example, with the button 120 engaged with hole 108 as shown in FIG. 12, the user depresses button 120 overcoming the force of spring 122. Once button 120 is depressed substantially within upper side tube 20, upper side tube 20 is free to slide axially relative to handle 50. The user then either extends or collapses the handle extension mechanism, choosing hole 110 or 106, respectively. For purposes of this example, it is assumed that the user wishes to collapse the handle 50; therefore the user chooses hole 106. As the user slides upper side tube 20 axially relative to handle 50, he or she aligns the button 120 with hole 106. As the button comes into alignment with hole 106, the force of spring 122 pushes button 120 through hole 106. With the button 120 extending through hole 106, frame piece 20 is locked in position relative to handle 50. The same method of operation is used to extend or collapse the handle extension mechanism 100 such that the button 120 extends through any one of holes 106, 108, 110.

It is within the scope of the invention to cover holes 106, 108, 110 such that a user can depress button 120 without directly pushing on button 120 itself. The cover may comprise, but is not limited to, plastic buttons or a flexible membrane. It is also within the scope of the invention to switch the orientation of the handle extension mechanism 100 such that the handle 50 slides within the lower portion 101 and upper portion 104 and the frame piece 20 is rigidly attached around the engagement portions 112, 114 of the lower portion 101 and upper portion 104. In other words, it is within the scope of the invention to utilize a similar extension mechanism on a stroller having handles of smaller diameter than the frame.

Although exemplary embodiments incorporate tubular metal frame members, it is within the scope of the invention to utilize metal frame members having alternative cross sections (such as, but not limited to square, rectangular, oval, C-shaped, L-shaped, etc.). It is also within the scope of the invention to utilize frame members composed of other materials (such as, but not limited to, plastic, fiberglass, or other composite materials).

While exemplary embodiments of the invention have been set forth above for the purpose of disclosure, modifications of the disclosed embodiments of the invention as well as other embodiments thereof may occur to those skilled in the art. Accordingly, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the stated advantages or objects of the invention disclosed herein to fall within the scope of the claims, since inherent and/or unforeseen advantages of the present invention may exist even though they may not have been explicitly discussed herein.

What is claimed is:

1. A stroller comprising:
a first frame member, the first frame member having generally an S-shape with a first inflection point;
a second frame member, the second frame member having generally an S-shape that is approximately a mirror image of the first frame member and the second frame member having a second inflection point;
wherein the first frame member and the second frame member are pivotably coupled together proximate the first inflection point and the second inflection point such that the first frame member and second frame member form a substantially coplanar X-shape.

2. The stroller of claim 1, wherein the first frame member and the second frame member each have a first end and a second end and wherein a length from the first end of the first frame member to the first inflection point is greater than a length from the second end of the first frame member to the first inflection point.

3. The stroller of claim 2, wherein the first frame member and the second frame member comprise a generally vertical support frame, the support frame being pivotably connected to lower frame members and upper frame members.

4. A stroller comprising:
a frame, the frame including a vertical supporting member and a lower separator assembly;
wherein the lower separator assembly is suspended from the vertical supporting member by a bracket such that the lower separator assembly is oriented substantially horizontally and such that substantially all of the lower separator assembly is located beneath the vertical height at which the bracket is attached to the vertical supporting member.

5. The stroller of claim 4, wherein the bracket is an L-shaped bracket.

6. The stroller of claim 5, wherein the bracket is pivotably coupled to the vertical supporting member using at least one axial coupling member.

7. The stroller of claim 5, wherein the bracket is pivotably coupled to the lower separator assembly using at least one axial coupling member.

8. A stroller comprising:
a frame, the frame including
a first upper frame member, and
a second upper frame member;
a first handle; and
a second handle;
wherein the first handle is slidably coupled with the first upper frame member and the second handle is slidably coupled with the second upper frame member such that each of the first handle and the second handle is independently movable.

9. The stroller of claim 8, further comprising
a first pin extending perpendicularly through the first frame member;
a second pin extending perpendicularly though the second frame member;
a first spring retainer, the first spring retainer being mounted within the first frame member and including a first button extending through a first hole in the first frame member, the button being spring-biased radially outward from a center of the first frame member;
a second spring retainer, the second spring retainer being mounted within the second frame member and including a second button extending through a second hole in the second frame member, the second button being spring-biased radially outward from a center of the second frame member;
a first collar, the first collar being rigidly attached to the first handle and slidably attached to the first upper frame member and having a longitudinal trough adapted to slidably receive the first pin and a plurality of holes adapted to engage the first button; and
a second collar, the second collar being rigidly attached to the second handle and slidably attached to the second upper frame member and having a longitudinal trough adapted to slidably receive the first pin and a plurality of holes adapted to engage the second button.

10. The stroller of claim 9, wherein the first handle and the second handle have larger diameters than the first upper frame member and the second upper frame member.

11. The stroller of claim 9, wherein the first handle and the second handle are at least partially covered with foam.

12. A stroller comprising:
a frame, the frame including handles;
a storage console mounted to the frame proximate the handles, the storage console comprising a pliant material;
wherein the storage console includes a plurality of pockets

13. The stroller of claim 12, wherein the plurality of pockets includes at least one pocket adapted to hold a beverage container.

14. The stroller of claim 13, wherein the plurality of compartments includes at least two beverage pockets, each beverage pocket adapted to hold a beverage container, and at least one center pocket located between the beverage pockets.

15. The stroller of claim 14, further comprising a pocket located generally beneath the beverage pockets and the center pocket.

16. The stroller of claim 15, wherein at least one of the pockets includes a zipper.

17. The stroller of claim 12, wherein the pliant material is a woven fabric.

18. The stroller of claim 12, wherein the pliant material is a non-woven fabric.

19. The stroller of claim 12, wherein at least a portion of the storage console is constructed from a mesh material.

20. The stroller of claim 12, wherein at least a portion of the storage console is releaseably attached to the frame.
